(19) United States
(12) Patent Application Publication
(10) Pub. No.: US 2025/0310779 A1
(43) Pub. Date: Oct. 2, 2025

(54) SPECTRUM ACCESS SYSTEM CHARGE ASSESSMENT IN A CITIZENS BROADBAND RADIO SERVICE NETWORK

(71) Applicant: Charter Communications Operating, LLC, St. Louis, MO (US)

(72) Inventors: Saran Khalid, Denver, CO (US); MohammedYusuf M. Shaikh, Aurora, CO (US); Mirza Kashif Baig Mirza Ismail Baig, Brampton (CA)

(73) Assignee: Charter Communications Operating, LLC, St. Louis, MO (US)

(21) Appl. No.: 18/616,494

(22) Filed: Mar. 26, 2024

(51) Int. Cl. H04W 16/14; H04L 12/14

(52) U.S. Cl. CPC H04W 16/14; H04L 12/1407

(57) ABSTRACT

Methods and systems for spectrum access system charge assessment in a Citizens Broadband Radio Service (CBRS) network are described. A method for spectrum access system charge assessment in a Citizens Broadband Radio Service (CBRS) network includes receiving, by a core network from a core compatibility system, a dummy user equipment identity for each CBRS device (CBSD) in a CBRS network. A policy control function (PCF) receives, from the core compatibility system, a charging policy for each CBSD in the CBRS network. The PCF determines a spectrum access system charge for a CBSD based on a session time, an associated dummy user equipment identity, and an associated charging policy, wherein the session time is based on a time of a registration event and a time of a session termination event.

### TECHNICAL FIELD

This disclosure relates to wireless communications. More specifically, determining spectrum access system charge assessment for use of a Citizens Broadband Radio Service (CBRS) cell.

### BACKGROUND

Wireless telecommunications or radio access technologies (RATs) generally use licensed radio frequency spectrum for communications between mobile devices and wireless telecommunications networks. For example, licensed spectrum is used for third generation (3G), fourth generation (4G), and fifth generation (5G) wireless communications. Wireless telecommunications technologies may also use unlicensed spectrum.

Citizens Broadband Radio Service (CBRS) spectrum is a type of unlicensed spectrum or shared radio frequency spectrum which is shared between multiple entities including government users (such as the military), licensed users, and non-licensed users. CBRS is a multitiered wireless band between 3.550 MHz and 3.700 MHz. In particular, CBRS is a three-tiered access framework including incumbent users (i.e., federal, military, and the like), priority access users (winning auction bidders) who have Priority Access Licenses (PALs) to CBRS spectrum, and general authorized access (GAA) users, where the general users are permitted to use any portion of the CBRS spectrum not assigned to a higher tier user and may also operate opportunistically on unused priority access spectrum. Availability of CBRS spectrum dynamically changes depending on use by higher priority entities. Higher tier users are protected from lower tier users using a centralized spectrum access system (SAS). The SAS authorizes or grants spectrum to access points known as CBRS Devices (CBSDs) and performs interference management to protect higher tier users. This protection may include, for example, dropping CBSDs which are general authorized access users. In summary, CBRS is an interference limited network which means that the performance of the network and the data sent to CBRS subscribers is limited by the amount of interference the CBRS users or subscribers experience in the frequency band of operation.

The SAS can be provided by, but not limited to, a federal entity, a commercial entity, and/or applicable third party vendor. These entities can track and assess charges for SAS services and/or usage, such as but not limited to, spectrum grant, registration, and spectrum management. However, there is no system and/or method for a service provider to track SAS usage and confirm that the correct charges are being incurred.

### SUMMARY

Disclosed herein is a system and method for spectrum access system charge assessment in a Citizens Broadband Radio Service (CBRS) network. In an implementation, a method for spectrum access system charge assessment in a Citizens Broadband Radio Service (CBRS) network includes receiving, by a core network from a core compatibility system, a dummy user equipment identity for each CBRS device (CBSD) in a CBRS network. A policy control function (PCF) receives, from the core compatibility system, a charging policy for each CBSD in the CBRS network. The PCF determines a spectrum access system charge for a CBSD based on a session time, an associated dummy user equipment identity, and an associated charging policy, wherein the session time is based on a time of a registration event and a time of a session termination event.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example of a wireless network architecture in accordance with embodiments of this disclosure.

FIG. 2 is a diagram of an example of the wireless network in the wireless network architecture of FIG. 1 in accordance with embodiments of this disclosure.

FIG. 3 is a flow diagram of an example of a system with spectrum access system charge assessment in a Citizens Broadband Radio Service (CBRS) network in accordance with embodiments of this disclosure.

FIG. 4 is a flowchart of an example method for spectrum access system charge assessment in a Citizens Broadband Radio Service (CBRS) network in accordance with embodiments of this disclosure.

FIG. 5 is a block diagram of an example of a device in accordance with embodiments of this disclosure.

### DETAILED DESCRIPTION

Reference will now be made in greater detail to embodiments, examples of which are illustrated in the accompanying drawings. Wherever possible, the same reference numerals will be used throughout the drawings and the description to refer to the same or like parts.

As used herein, the terminology “server”, “computer”, “computing device or platform”, or “cloud computing system” includes any unit, or combination of units, capable of performing any method, or any portion or portions thereof, disclosed herein. For example, the “server”, “computer”, “computing device or platform”, or “cloud computing system” may include at least one or more processor(s).

As used herein, the terminology “processor” or “processing circuitry” indicates one or more processors, such as one or more special purpose processors, one or more digital signal processors, one or more microprocessors, one or more controllers, one or more microcontrollers, one or more application processors, one or more central processing units (CPU) s, one or more graphics processing units (GPU) s, one or more digital signal processors (DSP) s, one or more application specific integrated circuits (ASIC) s, one or more application specific standard products, one or more field programmable gate arrays, any other type or combination of integrated circuits, one or more state machines, or any combination thereof.\

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory and hardware that is hard-wired into the processing circuitry.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the term “memory” includes one or more memories, where each memory may be a computer-readable medium. A memory may encompass memory hardware units (e.g., a hard drive or a disk) that store data or instructions in software form. Alternatively or in addition, the memory may include data or instructions that are hard-wired into processing circuitry. The memory may include a single memory unit or multiple joint or disjoint memory units, which each of the multiple joint or disjoint memory units storing all or a portion of the data described as being stored in the memory.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. For example, the memory can be non-transitory. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks, or activities. For example, applications may perform one or more functions including, but not limited to, telephony, web browsers, e-commerce transactions, media players, scheduling, management, smart home management, entertainment, and the like. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure and claims. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described embodiments that are relevant for a clear understanding of the herein disclosed processes, machines, and/or manufactures, while eliminating for the purpose of clarity other aspects that may be found in typical similar devices, systems, and methods. Those of ordinary skill may thus recognize that other elements and/or steps may be desirable or necessary to implement the devices, systems, and methods described herein. However, because such elements and steps do not facilitate a better understanding of the disclosed embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

Described herein is a system and method for tracking and determining SAS usage with respect to Citizens Broadband Radio Service (CBRS) cells and/or CBRS devices (CBSDs). The system enables the service provider to determine the SAS usage, active grant sessions, and registration of CBSDs, for example. The service provider can determine the service provider's reliance on the SAS provider and/or vendor, run analytics and make decisions, reconcile usage and charges incurred, and/or perform other metrics.

In implementations, an operations support system (OSS) and a policy control function (PCF) compatibility for SAS, CBSR networks, and/or CBSDs, and/or a core-CBRS compatibility function (PCS) in the service provider system can collectively or cooperatively provide to a core network a dummy end user for each CBSD that is registered with the SAS. The PCS can also provide charging policy information to the core network. The core network will then track a session time for the CBSD and determine a subsequent SAS charge or cost for review and use by the service provider. In implementations, the PCS can be a service provider component and/or be in the service provider system. In implementations, the PCS can be integrated with the OSS. In implementations, the PCS can be a core network component and/or be in the core network. In implementations, the PCS can be integrated with a policy control function (PCF).

In implementations, a core network can include, but is not limited to, the policy control function (PCF), a unified data management (UDM), and an application function (AF), which collectively assess data usage by end users using user equipment, e.g., mobile devices. The PCS can configure data associated with CBSDs so that the PCF, UDM, and AF can determine SAS usage by the CBSD. The PCS can formulate a unique dummy end user for each CBSD that is in the CBRS network, which is sent to the UDM. Accordingly, the PCF, UDM, and/or other core network components can treat each CBSD as user equipment. In implementations, the data for the CBSDs can be provided by the OSS and/or core network functions. In implementations, updates can be provided to the UDM, as applicable. Charging or assessment policies can be provided by the PCS to the PCF. The PCF can obtain session start information from the OSS via the PCS when the CBSD has registered and/or is active. The PCF can obtain session stop information from the OSS via the PCS when the CBSD has deregistered, SAS heartbeat has discontinued, SAS outage has been detected, and/or combinations thereof. The PCF will treat the data (e.g., session usage data) as it would user equipment data and provide usage reports. The service provider can use the usage reports to reconciliate with the SAS assessment, use the usage reports to prepare a charge (e.g., an invoice), use the usage reports for analytics, and/or combinations thereof. The usage reports can be provided to the service provider as attachments to messages exchanged between the core network and the service provider system.

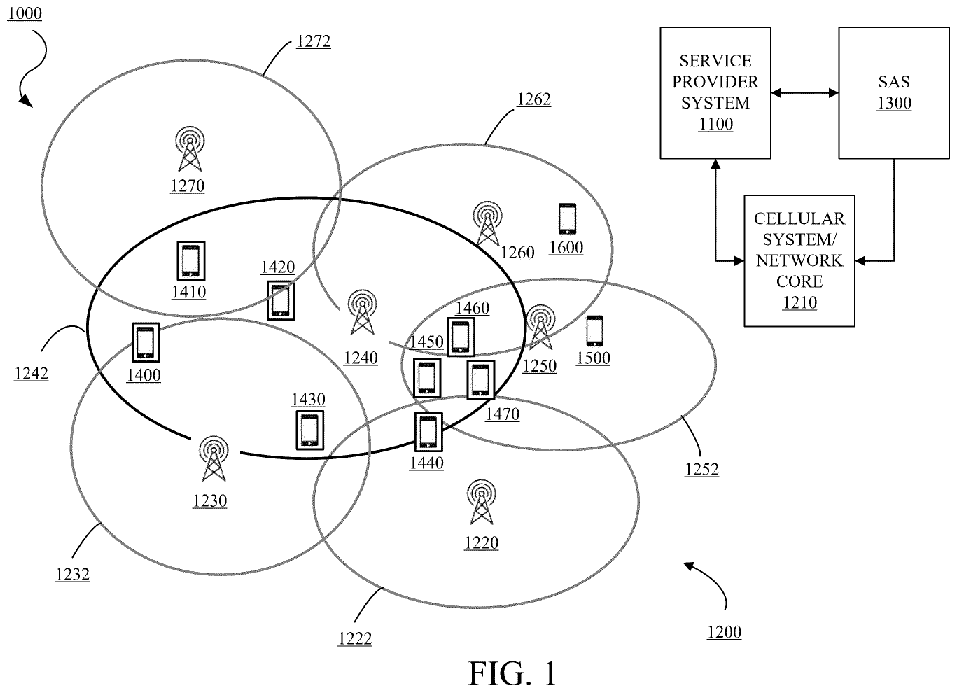

FIG. 1 is a diagram of an example wireless network architecture 1000. The wireless network architecture 1000 can include, but is not limited to, a service provider system 1100, a wireless, cellular, or multiple systems operator (MSO) system 1200, and a spectrum access system (SAS) 1300. The wireless network architecture 1000 can implement any wireless technology including, but not limited to, third generation (3G), fourth generation (4G), and fifth generation (5G) wireless communications and/or networks, and CBRS or shared spectrum wireless technologies and/or networks. In implementations, the wireless network architecture 1000 can be a hybrid mobile virtual network operator (HMNO) network where a service provider, which owns and operates the service provider system 1100 and can operate the MSO system 1200 as a mobile virtual network operator (MVNO). The number of components shown herein are illustrative and there may be more or less in the wireless network architecture 1000. The wireless network architecture 1000 and the components therein may include other elements which may be desirable or necessary to implement the devices, systems, and methods described herein. However, because such elements and steps do not facilitate a better understanding of the disclosed embodiments, a discussion of such elements and steps may not be provided herein.

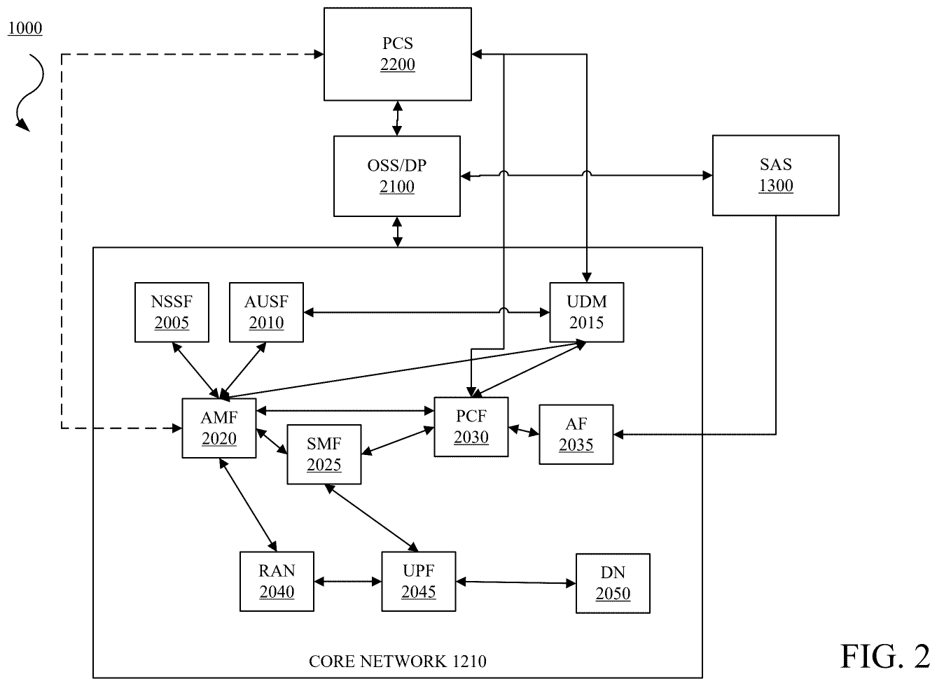

Referring now also to FIG. 2, the cellular system 1200 can include various functional components to address mobility management, authentication, session management, and other related functions with respect to, for example, one or more base stations 1220, 1230, 1240, 1250, 1260, and 1270. The cellular system 1200 can include, but is not limited to, a core network 1210 and the one or more base stations 1220, 1230, 1240, 1250, 1260, and 1270. Each of the one or more base stations 1220, 1230, 1240, 1250, 1260, and 1270 can be an access point, an access node, or like device which enables radio communications access between mobile devices 1400, 1410, 1420, 1430, 1440, 1450, 1460, 1470, 1500, 1600, and other devices in respective wireless coverage areas 1222, 1232, 1242, 1252, 1262, and 1272. Each of the one or more base stations 1220, 1230, 1240, 1250, 1260, and 1270 can support wireless communications via one or more of the 3G, the 4G, the 5G, and CBRS wireless technologies and/or networks. In the instance that a base station 1220, 1230, 1240, 1250, 1260, and 1270 uses or supports the CBRS spectrum, the base station 1220, 1230, 1240, 1250, 1260, and 1270 can be, in part, a CBSD, which has been granted or authorized CBRS spectrum by the SAS 1300.

In implementations, the core network 1210 can include, but is not limited to, a Network Slice Selection Function (NSSF) 2005, an Authentication Server Function (AUSF) 2010, a Unified Data Management (UDM) 2015, an Access and Mobility management Function (AMF) 2020, a Session Management Function (SMF) 2025, a Policy Control Function (PCF) 2030, an Application Function (AF) 2035, a Radio Access Network (RAN) 2040, a User Plane Function (UPF) 2045, and a Data Network (DN) 2050. The core network 1210 can function as described in the 3rd Generation Partnership Project (3GPP) specifications, which are incorporated herein by reference as if set forth herein. In implementations, the NSSF 2005 can handle network slice functions, the AUSF 2010 can handle authentication functions, the UDM 2015 can handle security credentials and store subscriber information for use by other functions, the AMF 2020 can handle control plane functions and connection and management mobility tasks, the SMF 2025 can handle calls and sessions, the PCF 2030 can handle processes to ensure that the user data traffic does not exceed the negotiated bearer(s) capacities, determine session times and/or usage, and determine charges based on session time and charging policy, the AF 2035 can control application(s) and provide charging and/or usage reports, the RAN 2040 can handle access, the UPF 2045 can handle the user data, and the DN 2050 can act as a user data repository.

The service provider system 1100 can include various functional components to address mobility management, authentication, session management, and other related functions with respect to, for example, the one or more base stations 1220, 1230, 1240, 1250, 1260, and 1270. The service provider system 1100 can include, but is not limited to, an operations support system (OSS) 2100. In implementations, the service provider can have PAL licenses and can operate on GAA in a CBRS network.

The OSS or domain proxy (DP) 2100 can work with the cellular system 1200, the core network 1210, a PCS or a core data compatibility and/or translation function and/or component 2200, the SAS 1400, and the other components in the service provider system 1100 to maintain information with respect to CBSDs comprising or in the CBRS network (“CBSD information”) and provide the CBSD information to the PCS 2200 and/or the core network 1210. In implementations, the OSS 2100 can provide updated CBSD information to the PCS 2200 and/or the core network 1210, as appropriate. The OSS 2100 can work with the cellular system 1200, the core network 1210, a policy control function (PCF) compatibility for SAS (PCS) 2200, the SAS 1400, and the other components in the service provider system 1100 to receive information as to when a CBSD has registered, received a grant, and/or a heartbeat response (collectively “registration information” or “registration event”) and provide the registration information to the PCS 2200. For instance, the OSS 2100 can receive registration information from a CBSD. The OSS 2100 can work with the cellular system 1200, the core network 1210, a policy control function (PCF) compatibility for SAS (PCS) 2200, the SAS 1400, and the other components in the service provider system 1100 to receive information from the SAS 1300 when a CBSD is not transmitting and/or when the SAS 1300 is not functioning and provide this information to the PCS 2200. The reasons for not transmitting information can include, but is not limited to, SAS outage, CBSD deregistration, heartbeat discontinued, grant suspension, and other issues (collectively “session closed information” or “session termination event”). The different types of session closed information can be used by the PCF 2030 to determine session charges.

In implementations, the wireless network architecture 1000 can include the PCS 2200. In implementations, the PCS 2200 can be a standalone system. In implementations, the PCS 2200 can be a service provider component and/or be in the service provider system 1100. In implementations, the PCS 2200 can be logically and/or physically integrated with the OSS 2100. In implementations, the PCS 2200 can be a core network component and/or be in the core network 1210. In implementations, the PCS 2200 can be logically and/or physically integrated with the PCF 2030.

The PCS 2200 can work with the cellular system 1200, the core network 1210, the SAS 1400, and the service provider system 1100 to receive the CBSD information for each of the CBSDs. In implementations, the PCS 2200 can obtain and/or receive the CBSD information from the AMF 2020. The PCS 2200 can generate a unique, dummy end user or user equipment identification for each CBSD, and provide the dummy end user identification to the UDM 2015 and/or the core network 1210. In implementations, the dummy end user identification can be a translation or mapping of the CBSD information to a dummy International Mobile Equipment Identity (IMEI). That is, the CBSD site name, registration number, and/or other CBSD specific identification can be translated or mapped to the dummy IMEI. The use of the dummy end user identification enables the PCF 2030 to track each CBSD session using a continuous data session as if it was user equipment. Fields in the IMEI not relevant or not needed for the dummy IMEI are set to null values. In implementations, the dummy end user identification can be a translation or mapping of the CBSD information to a dummy International Mobile Subscriber Identity (IMSI). The dummy IMSI can work as described herein for the dummy IMEI.

The PCS 2200 can work with the cellular system 1200, the core network 1210, the SAS 1400, and the service provider system 1100 to receive registration information from the OSS 2100 and/or the service provider system 1100 and provide the registration information to the PCF 2030. The PCS 2200 can work with the cellular system 1200, the core network 1210, the SAS 1400, and the service provider system 1100 to receive session closed information from the SAS 1300 and provide the registration information to the PCF 2030. The PCS 2200 can work with the cellular system 1200, the core network 1210, the SAS 1400, and the service provider system 1100 to provide charging policy information, service level information, and other related information to the PCF 2030.

The PCF 2030 and/or core network 1210 can work with the cellular system 1200, the SAS 1400, and the service provider system 1100 to receive the dummy end user identification, the charging policy, the registration information, and the session closed information to track session times for a CBSD, determine a subsequent SAS charge or cost based on the session time and the charging policy, and provide the SAS charge or cost to the AF 2035.

The AF 2035 and/or core network 1210 can work with the cellular system 1200, the SAS 1400, and the service provider system 1100 to receive the SAS charge or cost from the PCF 2030 to prepare a report for use by the service provider system 1100. In implementations, the AF 2035 and/or core network 1210 can receive a SAS charge as computed by the SAS 1300. The AF 2035 can analyze and/or reconcile the SAS charge or cost from the PCF 2030, the SAS charge as computed by the SAS 1300, and provide a report to the service provider system 1100.

The SAS 1300 can enable access to the CBRS spectrum and dynamically manage the spectrum for optimal use, efficiency, and compliance with CBRS rules. The SAS 1300 communicates with each base station 1220, 1230, 1240, 1250, 1260, and 1270 (which can be a CBSD or which supports CBRS) for registration, grant allocation/deallocation, heartbeat, interference management, suspension, outage, and/or other related issues. The SAS 1300 can perform interference analysis based on the power measurements received from mobile device(s) and make allocation and deallocation decisions based on the interference. The SAS 1300 may be operated by a commercial, federal entity, or some combinations thereof.

The mobile devices 1400, 1410, 1420, 1430, 1440, 1450, 1460, 1470, 1500, and 1600 can be, but is not limited to, Internet of Thing (IoT) devices, sensors, end user devices, cellular telephones, Internet Protocol (IP) devices, mobile computers, laptops, handheld computers, personal media devices, smartphones, notebooks, notepads, and the like, which can be provisioned for operation with a MSO, a MVNO, and/or service provider, can be provisioned for direct communication with each other and other mobile devices, and can be provided and provisioned by a service provider to operate in 3G, 4G, 5G, CBRS, and/or other wireless communication technologies and/or networks.

Operationally, the base stations 1220, 1230, 1240, 1250, 1260, and 1270 can be operating as a CBSD as part of a CRBS network in the wireless network architecture 1000 and/or cellular network 1200. The OSS 2100 can maintain a list of each CBSD provisioned in the CRBS network. The PCS 2200 can obtain CBSD information from the OSS 2100 and/or the AMF 2020. The PCS 2200 can generate dummy end users for each CBSD for registration on or with the UDM 2015 as masqueraded end users and/or user equipment. That is, each CBSD or radio cell can be masqueraded as an end user and/or user equipment, i.e., a mobile device.

The PCS 2200 can subscribe with the OSS 2100 to be informed each time a CBSD is registered i.e., when a CBSD is authorized and starts receiving a heartbeat. That is, information as to when the CBSD starts operating. The OSS 2100 can provide CBSDs that are registered and being serviced by the SAS 1300. The OSS 2100 can also provide information as to when a session has been closed or terminated. The PCS 2200 can take the data from OSS 2100 and translate it to AMF-like data for intake by the PCF 2030. That is, the data is now PCF-ingestible. The data here refers to the registration information and the session closed information. That is, PCS 2200 can reformat the registration information and data and the session closed information and data received from the OSS 2100 to an AMF data format for use by the PCF 2030. As an illustrative example, the AMF format can be as described for Npcf_AMPolicyControl_Create request and response messages as described in 3GPP specifications including, but not limited to, ETSI TS 129 513 and ETSI TS 129 507, the contents of which are herein incorporated by reference as if set forth in their entirities. Fields which are used for session time or length determination are populated and the remaining fields can be entered with dummy data or left blank.

The PCF 2030 can use the dummy end user information from the UDM 2015 and the registration information and data and the session closed information and data (now reformatted) from the PCS 2200 to determine session lengths or time intervals for the CBSDs. The PCF 2030 can determine and correlate the information as it would for user equipment and provide the charging information using the charging policy and session length. In addition, the PCF 2030 can also determine if there was a system wide outage from the SAS 1300 based on session closed information received from the OSS 2100 and can exclude that time. The AF 2035 can prepare reports based on the PCF 2030 determinations. In implementations, the AF 2035 reports can include SAS charging data. The reports can be used by the service provider. In implementations, the service provider and/or the PCS 2200 can compare the PCF 2030 data with the SAS data to determine accuracy and produce a report for charge reconciliation, for example.

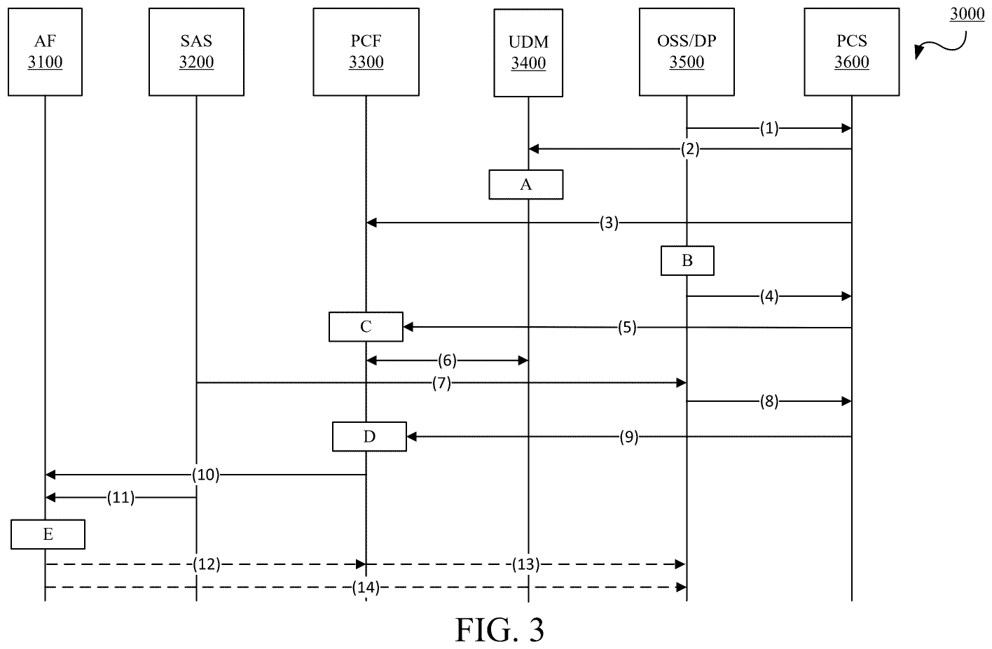

FIG. 3 is a flow 3000 of an example of a system with spectrum access system charge assessment in a Citizens Broadband Radio Service (CBRS) network in accordance with embodiments of this disclosure. The flow 3000 is performed between a AF 3100, a SAS 3200, a PCF 3300, a UDM, 3400, an OSS 3500, and a PCS 3600. Each of the components listed in FIG. 3 can function as described herein with respect to FIGS. 1 and 2.

In the flow 3000, the OSS 3500 can maintain information, which can include but is not limited to site information, for provisioned CBSDs for operation in a CRBS network and can provide the CBSD information to the PCS 3600 (1). The PCS 3600 can generate unique end user or user equipment (UE) identifications for each CBSD (“dummy UE”). The PCS 3600 can provide the dummy UEs to the UDM 3400 (2). The UDM 3400 can store the dummy UEs (A) and share the dummy UEs with the PCF 3300 as needed and as described herein. The PCS 3600 can provide policy information, including but not limited to, charging or cost policy information, to the PCF 3300 (3).

The OSS 3500 can receive registration information for one or more CBSDs (B). The OSS 3500 can provide the registration information to the PCS 3600 (3). The PCS 3600 can reformat the registration information for use by the PCF 3300. The PCS 3600 can send the reformatted registration information to the PCF 3300 (5). The PCF 3300 can obtain the dummy UE information from the UDM 3400 associated with the reformatted registration information (6). The PCF 3300 can record session information, including but not limited to session length, for each CBSD via the dummy UE information. For instance, the PCF 3300 can start a timer, set a flag, start a counter, and/or use a timing mechanism so as to be able to determine a session length.

The SAS 3200 can send session closed information to the OSS 3500 (7). The session closed information can include, but is not limited to, SAS outage information, CBSD deregistration, SAS grant suspension, lack of heartbeat information, and/or other reasons or issues for session termination. The OSS 3500 can provide the session closed information to the PCS 3600 (8). The PCS 3600 can reformat the session closed information for use by the PCF 3300. The PCS 3600 can send the reformatted session closed information to the PCF 3300 (9).

The PCF 3300 can calculate the session information including, but not limited to, the session length (D). The PCF 3300 can account for SAS related issues when determining the session information and/or session length. That is, the PCF 3300 can deduct time due to SAS related issues. The PCF 3300 can provide a report with the session information to the AF 3100 (10). The SAS 3200 can provide a charge or pricing report to the AF 3100 (11). The AF 3100 can generate cost reports based on the session information report from the PCF 3300 and the charge or pricing report from the SAS 3200 (E). In implementations, the cost reports from the AF 3100 can include comparative data as between the session information report from the PCF 3300 and the charge or pricing report from the SAS 3200. In implementations, the AF 3100 can provide the cost reports to the PCS 3600 (12), which in turn can process and provide the cost report to the OSS 3500 and/or service provider (13) for cost reconciliation, if appropriate. In implementations, the AF 3100 can provide the cost reports to the OSS 3500 and/or service provider (14) for cost reconciliation, if appropriate.

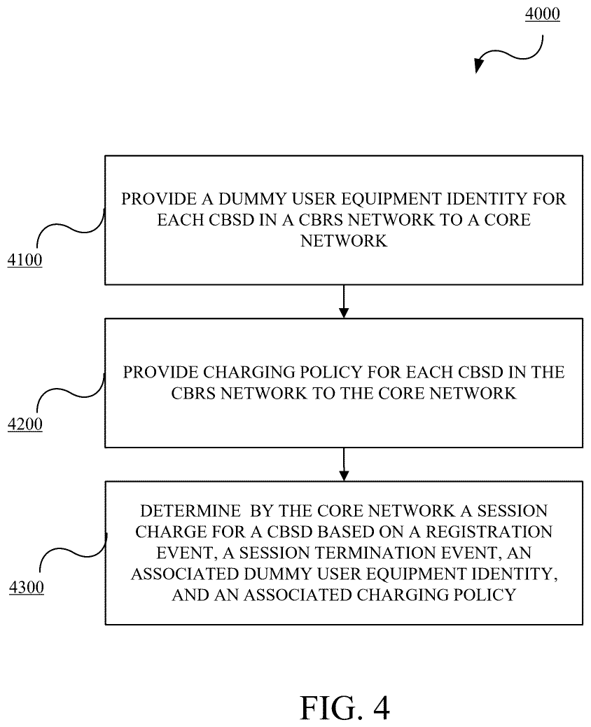

FIG. 4 is a flowchart of an example method 4000 for spectrum access system charge assessment in a Citizens Broadband Radio Service (CBRS) network in accordance with embodiments of this disclosure. The method 4000 includes: providing 4100 a dummy user equipment identity for each CBSD in a CBRS network to a core network; providing 4200 charging policy for each CBSD in the CBRS network to the core network; and determining 4300 by the core network a session charge for a CBSD based on a registration event, a session termination event, an associated dummy user equipment identity, and an associated charging policy. The method 4000 can be implemented, for example, in or by components described with respect to FIGS. 1-3 and in conjunction with any of the flows described with respect to FIGS. 1-3. as appropriate and applicable.

The method 4000 includes providing 4100 a dummy user equipment identity for each CBSD in a CBRS network to a core network. An OSS in the service provider system and or an AMF in a core network can maintain a list of CBSDs in a CBRS network. A PCS or core compatibility component and/or system can obtain the CBSD information and generate a dummy user equipment identity for each CBSD in the CBRS network. Each dummy user equipment identity is unique to a CBSD. The PCS provides the dummy user equipment identities to the core network. In implementations, the dummy user equipment identities are provided to the UDM.

The method 4000 includes providing 4200 charging policy for each CBSD in the CBRS network to the core network. The charging policies for each CBSD is provided by the OSS and/or service provider system to the PCS.

The method 4000 includes determining 4300 by the core network a session charge or a spectrum access system charge for a CBSD based on a registration event, a session termination event, an associated dummy user equipment identity, and an associated charging policy. The OSS can receive a registration event from a CBSD. The OSS and/or the service provider system can provide the registration event to the PCF via the PCS. The PCS can reformat the registration event for use by the PCF. In implementations, the registration event is reformatted to a AMF-type data format. The OSS can receive a session termination event from a SAS. The OSS and/or the service provider system can provide the session termination event to the PCF via the PCS. The PCS can reformat the session termination event for use by the PCF. In implementations, the session termination event is reformatted to an AMF-type data format. The session termination event can include, but is not limited to, SAS based termination events. The PCS can determine a session length based on a time of the registration event and a time of the session termination event. The session length can be adjusted based on a length of time of one or more SAS based termination events. The adjusted session length and the charging policy can be used to determine a session charge or cost. An AF or the core network can generate, provide, and/or display a session charging report based on the session charge. In implementations, the session charging report can include a SAS provided session charge. The core network provided session charge and the SAS provided session charge can be reconciled to determine an accuracy of the SAS provided session charge.

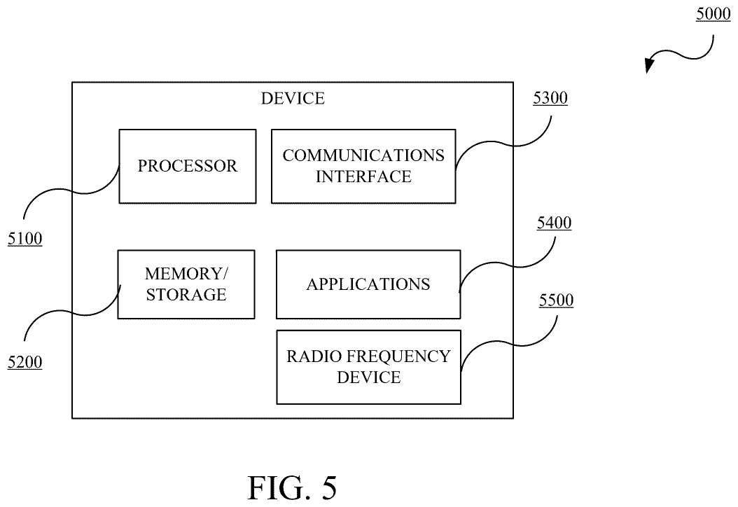

FIG. 5 is a block diagram of an example of a device 5000 in accordance with embodiments of this disclosure. The device 5000 may include, but is not limited to, a processor 5100, a memory/storage 5200, a communication interface 5300, applications 5400, and, if needed, a radio frequency device 5500. The device 5000 may include or implement, for example, the components described with respect to FIGS. 1-3. The applicable or appropriate flows, techniques, or methods described herein may be stored in the memory/storage 5200 and executed by the processor 5100 in cooperation with the memory/storage 5200, the communications interface 5300, the applications 5400, and the radio frequency device 5500 (when applicable), as appropriate. The device 5000 may include other elements which may be desirable or necessary to implement the devices, systems, and methods described herein. However, because such elements and steps do not facilitate a better understanding of the disclosed embodiments, a discussion of such elements and steps may not be provided herein.

Described herein is a method for spectrum access system charge assessment in a Citizens Broadband Radio Service (CBRS) network. In an implementation, a method includes receiving, by a core network from a core compatibility system, a dummy user equipment identity for each CBRS device (CBSD) in a CBRS network. A policy control function (PCF) receives from the core compatibility system a charging policy for each CBSD in the CBRS network. The PCF determines a spectrum access system charge for a CBSD based on a session time, an associated dummy user equipment identity, and an associated charging policy, wherein the session time is based on a time of a registration event and a time of a session termination event.

In implementations, the dummy user equipment identity masquerades an identity of a CBSD identity for use by the PCF and the core network. In implementations, the dummy user equipment identity can be in one of an International Mobile Equipment Identity (IMEI) format or an International Mobile Subscriber Identity (IMSI) format. In implementations, the core compatibility system generates the dummy user equipment identity for each CBRS device (CBSD) in the CBRS network based on an identity of the CBSD. In implementations, the core compatibility system receives from a service provider system, the registration event for the CBSD, reformats the registration event to a PCF-ingestible registration event, provides the PCF-ingestible registration event to the PCF, and the method further includes initiating, by the PCF, tracking of a session for the CBSD in response to receiving the PCF-ingestible registration event. In implementations, the core compatibility system receives from a spectrum access system via a service provider system, the session termination event for the CBSD, reformats the session termination event to a PCF-ingestible session termination event, provides the PCF-ingestible session termination event to the PCF, and the method further includes stopping, by the PCF, the tracking of the session for the CBSD in response to receiving the PCF-ingestible session termination event. In implementations, the session termination event includes a spectrum access system termination event and the determining further includes adjusting, by the PCF, the session time based on a time length associated with the spectrum access system termination event.

Described herein is a system for spectrum access system charge assessment in a Citizens Broadband Radio Service (CBRS) network. In implementations, the system includes a data management function, a policy control function (PCF) connected to the data management function, and a policy control function compatibility for spectrum access system (PCS) connected to the data management function and the policy control function. The PCS configured to generate a dummy identity for each CBRS device (CBSD) in a CBRS network for use and storage by the data management function, provide a charging policy for each CBSD in the CBRS network for use by the PCF, provide a use compatible registration event for a CBSD for use by the PCF, provide a use compatible session termination event for the CBSD for use by the PCF, and the PCF configured to determine a spectrum access system charge for the CBSD based on a session time determined from a time of the use compatible registration event and a time of the use compatible session termination event, a dummy identity for the CBSD, and a charging policy for the CBSD.

In implementations, the dummy identity masquerades an identity of a CBSD identity for use by the PCF and the data management function. In implementations, the dummy identity can be in one of an International Mobile Equipment Identity (IMEI) format or an International Mobile Subscriber Identity (IMSI) format. In implementations, the PCS further configured to receive a registration event for the CBSD from a service provider system, and format the registration event to the use compatible registration event. In implementations, the PCF further configured to start a session for the CBSD in response to receiving the use compatible registration event. In implementations, the PCS further configured to receive a session termination event for the CBSD from a spectrum access system via a service provider system, and format the session termination event to the use compatible session termination event. In implementations, the PCF further configured to stop a session for the CBSD in response to receiving the use compatible session termination event. In implementations, the session termination event includes a spectrum access system termination event and the PCF further configured to adjust the session time based on a time length associated with the spectrum access system termination event.

Described herein is a method for spectrum access system charge assessment in a Citizens Broadband Radio Service (CBRS) network. In implementations, the method includes generating, by a core-CBRS compatibility function, a dummy identity for each CBRS device (CBSD) in a CBRS network for use by a policy control function (PCF). The core-CBRS compatibility function, provides a charging policy for each CBSD in the CBRS network for use by the PCF, provides a use compatible registration event for a CBSD for use by the PCF, and provides a use compatible session termination event for the CBSD for use by the PCF. A session charge assessment is received from the PCF for the CBSD based on a session time determined from a time of the use compatible registration event and a time of the use compatible session termination event, a dummy identity for the CBSD, and a charging policy for the CBSD.

In implementations, the dummy identity masquerades an identity of a CBSD identity for use by the PCF and a core network. In implementations, the dummy identity can be in one of an International Mobile Equipment Identity (IMEI) format or an International Mobile Subscriber Identity (IMSI) format. In implementations, the method further includes receiving, from a service provider system, a registration event for the CBSD, and formatting, by the core-CBRS compatibility function, the registration event to the use compatible registration event, where the PCF initiates tracking of a session of the CBSD in response to receipt of the use compatible registration event. In implementations, the method further includes receiving, from a spectrum access system via the service provider system, a session termination event for the CBSD, and formatting, by the core-CBRS compatibility function, the session termination event to the use compatible session termination event, where the PCF stops tracking of the session of the CBSD in response to receipt of the use compatible session termination event.

Although some embodiments herein refer to methods, it will be appreciated by one skilled in the art that they may also be embodied as a system or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects may take the form of a computer program product embodied in one or more the computer readable mediums having the computer readable program code embodied thereon. For example, the computer readable mediums can be non-transitory. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

As used herein, the term “computer-readable medium” encompasses one or more computer-readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

Computer program code for carrying out operations for aspects may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects are described herein with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain embodiments, it is to be understood that the disclosure is not to be limited to the disclosed embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

What is claimed is:

1. A method for spectrum access system charge assessment in a Citizens Broadband Radio Service (CBRS) network, the method comprising:
receiving, by a core network from a core compatibility system, a dummy user equipment identity for each CBRS device (CBSD) in a CBRS network;
receiving, by a policy control function (PCF) from the core compatibility system, a charging policy for each CBSD in the CBRS network; and
determining, by the PCF, a spectrum access system charge for a CBSD based on a session time, an associated dummy user equipment identity, and an associated charging policy, wherein the session time is based on a time of a registration event and a time of a session termination event.

2. The method of claim 1, wherein the dummy user equipment identity masquerades an identity of a CBSD identity for use by the PCF and the core network.

3. The method of claim 2, wherein the dummy user equipment identity can be in one of an International Mobile Equipment Identity (IMEI) format or an International Mobile Subscriber Identity (IMSI) format.

4. The method of claim 2, wherein the core compatibility system generates the dummy user equipment identity for each CBRS device (CBSD) in the CBRS network based on an identity of the CBSD.

5. The method of claim 1, wherein the core compatibility system receives from a service provider system, the registration event for the CBSD, reformats the registration event to a PCF-ingestible registration event, provides the PCF-ingestible registration event to the PCF, and the method further comprising:
initiating, by the PCF, tracking of a session for the CBSD in response to receiving the PCF-ingestible registration event.

6. The method of claim 5, wherein the core compatibility system receives from a spectrum access system via a service provider system, the session termination event for the CBSD, reformats the session termination event to a PCF-ingestible session termination event, provides the PCF-ingestible session termination event to the PCF, and the method further comprising:
stopping, by the PCF, the tracking of the session for the CBSD in response to receiving the PCF-ingestible session termination event.

7. The method of claim 1, wherein the session termination event includes a spectrum access system termination event and the determining further comprising:
adjusting, by the PCF, the session time based on a time length associated with the spectrum access system termination event.

8. A system, comprising:
a data management function;
a policy control function (PCF) connected to the data management function; and
a policy control function compatibility for spectrum access system (PCS) connected to the data management function and the policy control function, the PCS configured to:
generate a dummy identity for each CBRS device (CBSD) in a CBRS network for use and storage by the data management function;
provide a charging policy for each CBSD in the CBRS network for use by the PCF;
provide a use compatible registration event for a CBSD for use by the PCF;
provide a use compatible session termination event for the CBSD for use by the PCF; and
the PCF configured to determine a spectrum access system charge for the CBSD based on a session time determined from a time of the use compatible registration event and a time of the use compatible session termination event, a dummy identity for the CBSD, and a charging policy for the CBSD.

9. The system of claim 8, wherein the dummy identity masquerades an identity of a CBSD identity for use by the PCF and the data management function.

10. The system of claim 8, wherein the dummy identity can be in one of an International Mobile Equipment Identity (IMEI) format or an International Mobile Subscriber Identity (IMSI) format.

11. The system of claim 8, the PCS further configured to:
receive a registration event for the CBSD from a service provider system; and
format the registration event to the use compatible registration event.

12. The system of claim 8, the PCF further configured to:
start a session for the CBSD in response to receiving the use compatible registration event.

13. The system of claim 8, the PCS further configured to:
receive a session termination event for the CBSD from a spectrum access system via a service provider system; and
format the session termination event to the use compatible session termination event.

14. The system of claim 8, the PCF further configured to:
stop a session for the CBSD in response to receiving the use compatible session termination event.

15. The system of claim 8, wherein the session termination event includes a spectrum access system termination event and the PCF further configured to:
adjust the session time based on a time length associated with the spectrum access system termination event.

16. A method for session charge assessment in a Citizens Broadband Radio Service (CBRS) spectrum, the method comprising:
generating, by a core-CBRS compatibility function, a dummy identity for each CBRS device (CBSD) in a CBRS network for use by a policy control function (PCF);
providing, by the core-CBRS compatibility function, a charging policy for each CBSD in the CBRS network for use by the PCF;
providing, by the core-CBRS compatibility function, a use compatible registration event for a CBSD for use by the PCF;
providing, by the core-CBRS compatibility function, a use compatible session termination event for the CBSD for use by the PCF; and
receiving, from the PCF, a session charge assessment for the CBSD based on a session time determined from a time of the use compatible registration event and a time of the use compatible session termination event, a dummy identity for the CBSD, and a charging policy for the CBSD.

17. The method of claim 16, wherein the dummy identity masquerades an identity of a CBSD identity for use by the PCF and a core network.

18. The method of claim 16, wherein the dummy identity can be in one of an International Mobile Equipment Identity (IMEI) format or an International Mobile Subscriber Identity (IMSI) format.

19. The method of claim 16, further comprising:
receiving, from a service provider system, a registration event for the CBSD; and
formatting, by the core-CBRS compatibility function, the registration event to the use compatible registration event, wherein the PCF initiates tracking of a session of the CBSD in response to receipt of the use compatible registration event.

20. The method of claim 19, further comprising:
receiving, from a spectrum access system via the service provider system, a session termination event for the CBSD; and
formatting, by the core-CBRS compatibility function, the session termination event to the use compatible session termination event, wherein the PCF stops tracking of the session of the CBSD in response to receipt of the use compatible session termination event.
